(19) United States
(12) Patent Application Publication
(10) Pub. No.: US 2008/0178512 A1
(43) Pub. Date: Jul. 31, 2008

(54) Waterfowl decoy

(76) Inventor: Marlin M. Lessmann, Sioux City, IA (US)

Correspondence Address: Adam H. Jacobs;Law Offices of Adam H. Jacobs, Suite 726, 1904 Farnam Street, Omaha, NE, 68102, US

(21) Appl. No.: 12/011,882

(22) Filed: Jan. 30, 2008

Related U.S. Application Data
(60) Provisional application No. 60/898,230, filed on Jan. 30, 2007.

(51) Int. Cl. A01M 31/06

(52) U.S. Cl. 43/3

(57) ABSTRACT

An improved waterfowl decoy includes a molded plastic main body including an underside, the main body having the general configuration of a selected waterfowl and a keel structure including a longitudinally extended hollow keel tube mounted on the underside of the main body. An anchor weight is configured such that it fits within the hollow keel tube, and a generally tangle-free anchor line is connected to and extends from the anchor weight up to one end of the hollow keel tube and further extends through at least a portion of the hollow keel tube such that the anchor line extends at least partially through the hollow keel. Finally, the anchor weight fits within the hollow keel tube when the generally tangle-free anchor line is pulled up and through the hollow keel tube whereby the anchor weight is releasably securable within the hollow keel tube.

### CROSS-REFERENCE TO RELATED PATENTS

This application claims priority based on a provisional patent, specifically on the Provisional Patent Application Ser. No. 60/898,230 filed Jan. 30, 2007.

### BACKGROUND OF THE INVENTION

1. Technical Field

The present invention is directed to waterfowl decoys and, more particularly, to a duck decoy designed to float in water which includes a molded main body having the general configuration of a duck or other such waterfowl and a keel structure which includes a longitudinally extended hollow keel tube mounted or molded on the underside of the molded duck body and an anchor weight and tangle-free anchor line extending from the anchor weight up to the forward end of the hollow keel tube and extending through to the opposite end of the hollow keel tube such that the anchor line extends through the hollow keel tube, the anchor weight being of a size and shape to fit within the hollow keel tube when the tangle-free anchor line is pulled up and through the hollow keel tube at the opposite end thereof whereby the anchor weight may be releasably secured within the hollow keel tube thereby facilitating transport and storage of the improved duck decoy without tangling of multiple lines and anchors of adjacent decoys being transported or stored in the same storage container.

2. Description of the Prior Art

Waterfowl decoys are commonly used by hunters to attract waterfowl to an area in front of the location where the hunters are concealed. Many different shapes, sizes and color combinations are used in connection with the waterfowl decoys currently found in the prior art to replicate all different types of waterfowl, but the most commonly used types of decoys are those designed to replicate ducks of various species.

Most duck decoys include a body portion which is shaped generally like the waterfowl attempting to be replicated and a lower keel portion which is molded on the underside of the body portion and serves to keep the body portion upright to perform its intended function of attracting real waterfowl to the area. This keel may take many different forms, such as those shown in Igo, U.S. Pat. No. 6,647,657, or Martin, U.S. Pat. No. 5,168,650. Keels may generally be of either the weighted type or the water-flow type which fill with water to add stability to the decoy in swift water currents or in windy areas. These devices also disclose one of the other important features of such decoys, and that is that they each include an anchor weight which extends downwards from the keel section via an anchor line or cord to rest on the bottom of the body of water and keep the duck decoy in its selected location where it was initially placed. However, the transport and storage of duck decoys having such anchor weights and lines is problematic in that the user of such devices must wrap the cord around the decoy body, keel or neck, or around another such coiling device and it is quite common for such wrapped lines to come undone and become entangled with other decoys in the vicinity thereof. There is therefore a need for an improved duck decoy which includes a keel portion and anchor weight which will greatly facilitate storage and transport of the duck decoy and generally prevent tangling of the anchor lines and anchors during storage while also facilitating use of the improved duck decoy by making it much easier and faster to deploy the anchor and line for setting out the decoys for use. There is also a need for an improved duck decoy which will make it much easier and faster to retrieve and store multiple decoys in boxes or bags after use, which is of significant importance to users of duck decoys.

Therefore, an object of the present invention is to provide an improved waterfowl decoy.

Another object of the present invention is to provide an improved waterfowl decoy which includes a main waterfowl-shaped body and a hollow keel tube mounted on the underside thereof.

Another object of the present invention is to provide an improved waterfowl decoy which includes a tangle-free anchor line and an anchor weight attached thereto, the anchor weight at least partially fitting within the hollow keel tube for storage and transport of the waterfowl decoy.

Another object of the present invention is to provide an improved waterfowl decoy which will generally prevent tangling of multiple lines and anchors of adjacent decoys being transported or stored in the same storage container.

Finally, an object of the present invention is to provide improved waterfowl decoy which is relatively simple and durable in construction and is safe, efficient and effective in use.

### SUMMARY OF THE INVENTION

The present invention provides improved waterfowl decoy which includes a molded plastic main body including an underside, the main body having the general configuration of a selected waterfowl and a keel structure including a longitudinally extended hollow keel tube mounted on the underside of the main body. An anchor weight is configured such that at least a portion of the anchor weight fits within the hollow keel tube, and a generally tangle-free anchor line is connected to and extends from the anchor weight up to one end of the hollow keel tube and further extends through at least a portion of the hollow keel tube such that the anchor line extends at least partially through the hollow keel. Finally, the anchor weight at least partially fits within the hollow keel tube when the generally tangle-free anchor line is pulled up and through the hollow keel tube whereby the anchor weight is releasably securable at least partially within the hollow keel tube.

The present invention thus provides numerous advantages over the prior art. For example, because the anchor weight is drawn up within the keel tube when the decoy is not in use, it is far easier to store the decoy with others as the various anchor weights will not tangle. Furthermore, as the present invention includes a hollow keel tube, it is more stable in water than other such decoys, which improves the functionality of the duck decoy in the field. Finally, because the present invention includes a tangle-free anchor line which prevents tangling and snagging of adjacent duck decoys, use of the present invention is greatly facilitated, which therefore renders the present invention a substantial improvement over the prior art.

### BRIEF DESCRIPTION OF THE DRAWINGS

FIG. 1 is a side elevational view of the improved duck decoy of the present invention showing the decoy in use in a body of water;

FIG. 2 is a bottom perspective view of the molded keel structure of the present invention showing the elements thereof; and

FIG. 3 is a detailed cutaway side elevational view of the base of the improved duck decoy of the present invention showing the anchor weight being retained and stored within the hollow keel tube.

### DESCRIPTION OF THE PREFERRED EMBODIMENT

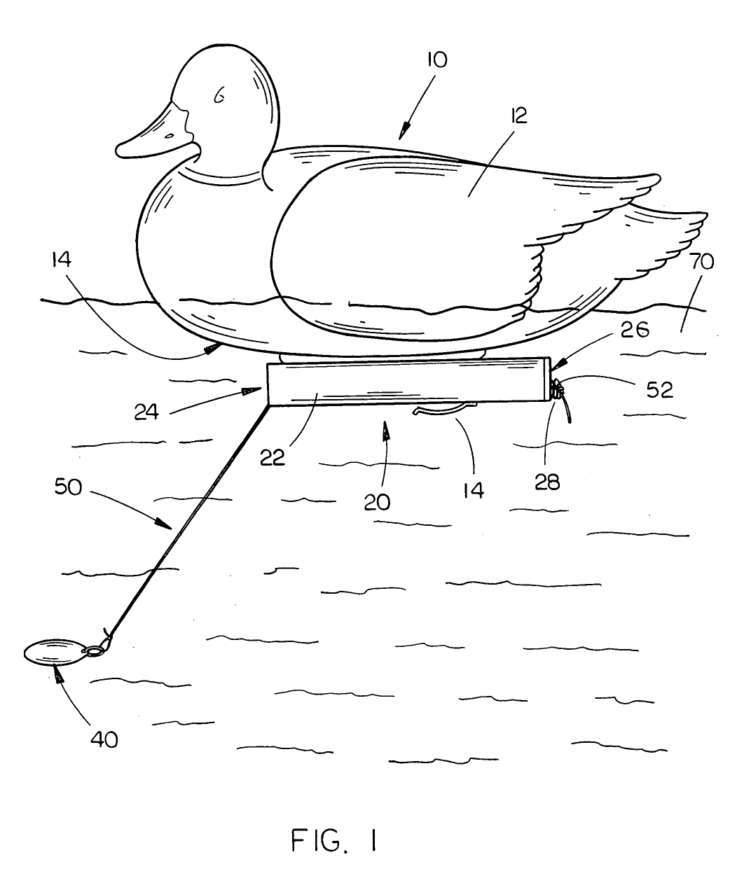

The improved duck decoy 10 of the present invention is shown best in FIGS. 1-3 as including a main body 12 which, in the preferred embodiment, would be constructed as a generally hollow molded plastic or solid Styrofoam waterfowl-shaped body having all of the salient features of the waterfowl which the main body 12 is to replicate. Of course, the size, shape and markings associated with the main body 12 may be modified or changed depending on the type of waterfowl the main body 12 is to resemble, with the important functional considerations for the main body 12 being that it be generally fluid tight and buoyant such that the main body 12 will float in water when placed therein.

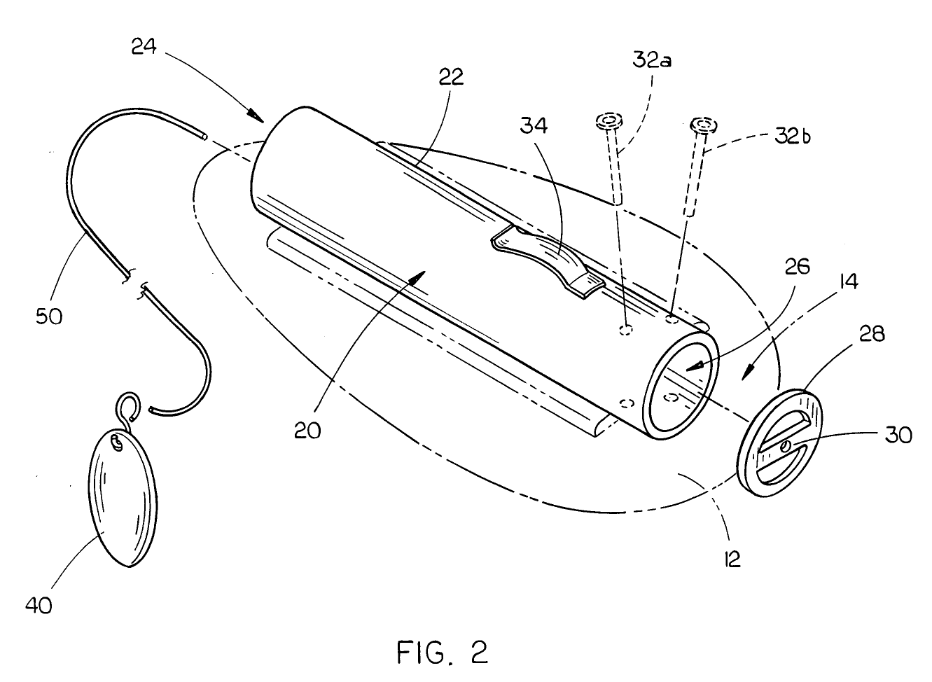

Molded on the underside 14 of main body 12 is a keel structure 20 which, in the preferred embodiment, would include an elongated generally cylindrical keel tube 22 having a forward end 24 which is open and a rearward end 26 which is partially covered and closed by a keel tube end bar 28 molded or mounted thereon, the keel tube end bar 28 having an end hole 30 extending therethrough, the keel tube end bar 28 only partially covering and closing the keel tube 22 so that water may flow through the keel tube 22, the importance of which will be described later in this disclosure. In the preferred embodiment, the keel tube 22 would have a length of approximately three to ten inches and a diameter of approximately one-half inch to one inch, with the keel tube 22 being constructed of a PVC plastic material, Styrofoam material or the like for durability and ease of construction. The keel tube 22 would be mounted on the underside 14 of main body 12 preferably by being integrally molded with the main body 12, although an alternative mounting may be achieved by using a pair of rivets 32a and 32b, as shown by the dotted line drawings in FIG. 2, or any other such connection device to secure the keel tube 22 to the underside 14 to the main body 12. It should be noted that many other types of securement devices may be used with the present invention so long as the keel tube 22 is securely molded or mounted on the underside 14 of main body 12.

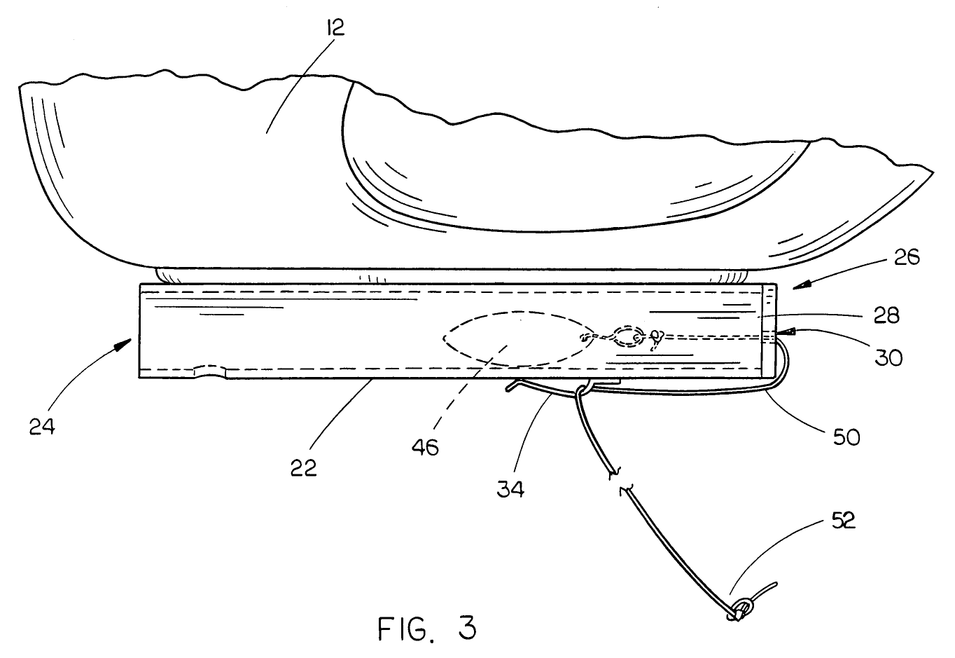

An anchor weight 40 is also provided, the anchor weight 40 preferably being a lead or other appropriate metal weight which may be generally cylindrical in shape, generally pointed on one or both ends, or another such shape to facilitate the anchor weight 40 entering and fitting within the keel tube 22 as will be described later in this disclosure. Extending upwards from the anchor weight 40 is an anchor line 50 which extends through the keel tube 22 from forward end 24 out through rearward end 26 through the keel tube end bar 28, specifically end hole 30, as shown best in FIGS. 1 and 3, the anchor line 50 preferably being a section of non-tangling plastic line to generally prevent twisting, tangling, and knotting of the anchor line 50. The anchor line 50 would preferably have a length of approximately three to six feet to permit the anchor weight 40 to dangle beneath the keel tube 22 of improved duck decoy 10 and touch the bottom of the body of water 70 the duck decoy 10 is floating in thus holding the duck decoy 10 in a selected position, as shown in FIG. 1. The anchor line 50 would further include a knot 52 formed at the end opposite anchor weight 40 which acts to prevent the anchor line 50 from slipping through the end hole 30 in keel tube end bar 28 through which the anchor line 50 extends, such that when the anchor weight 40 is fully deployed from the main body 12 of improved duck decoy 10, the knot 52 in anchor line 50 rests against the end hole 30 in keel tube end bar 28 through which the anchor line 50 extends, as shown best in FIG. 1. The extended length of the anchor line 50 may be adjusted by adjusting the position of the knot 52 on the line.

The significant benefit of the present invention, however, is shown best in FIG. 3 as when the improved duck decoy 10 is to be readied for transport or storage thereof. At such time, the anchor weight 40 may be drawn up into keel tube 22 by pulling anchor line 50 through end hole 30 of keel tube end bar 28 to move the anchor weight 40 upwards towards the keel tube 22 until the anchor weight 40 is housed entirely within the keel tube 22. The anchor line 50 may then be secured under an anchor line clip 34 mounted on the external surface of keel tube 22, as shown best in FIGS. 1-3. The remaining anchor line 50 may then be left to dangle freely since the tangle free construction material used for the anchor line 50 will prevent tangling of the anchor line 50 with other anchor lines of other decoys being stored together. Of course, the anchor line 50 may also be either wrapped around the anchor line clip 34 or wrapped around the main body 12 of duck decoy 10 as desired by the user of the present invention. However, because the anchor weight 40 is safely housed within keel tube 22, it is much less likely that multiple duck decoys stored or transported together in boxes, bags or bottoms of boats and other watercraft will become inextricably tangled due to interaction between the anchor weights and anchor lines of the various duck decoys being transported or stored adjacent to one another.

Furthermore, when it becomes time to once again deploy the duck decoys 10, the anchor weight 40 may be quickly and easily removed from the keel tube 22 by releasing the anchor line 50 from under the anchor line clip 34 and the weight of the anchor weight 40 will draw the anchor line 50 outwards through keel tube 22 to deploy the anchor weight 40 below the main body 12 of duck decoy 10. Deployment and retrieval of the improved duck decoy 10 thus becomes a far easier and efficient procedure than that available in connection with those duck decoys found in the prior art, and therefore the improvements of the present invention are believed to be deserving of protection.

It is to be understood that numerous additions, substitutions and modifications may be made to the improved duck decoy 10 of the present invention which fall within the intended broad scope of the above description. For example, the precise size, shape and construction materials used in connection with the main body 12 and the keel structure 20 may be modified or changed, and in fact the size, shape and length of the keel tube 22 may be modified or changed depending on the performance characteristics desired in connection with the duck decoy 10, so long as the intended functional feature of permitting the anchor weight 40 to be drawn into and retained within the keel tube 22 is generally maintained. Also, the main body 12 may be constructed of solid Styrofoam, any such extruded or high-impact polystyrene or plastic material, so long as the construction material can be molded or formed into the desired configuration of main body 12. Furthermore, the positioning of the various elements of the keel structure 20 may be reversed or modified so long as the intended functional features of the keel structure 20 are generally maintained, including switching the keel tube end bar 28 to the forward end 24 of keel tube 22 or, alternatively, eliminating the keel tube end bar 28 entirely and replacing the knot 52 on anchor line 50 with an enlarged anchor line stop device to prevent the anchor line 50 from merely falling through the keel tube 22. Finally, it should be noted that the anchor weight 40 may be of many different sizes, shapes and configurations as determined by the operational characteristics desired in connection with the improved duck decoy 10, and such modifications would be understood by one skilled in the art of anchor weights used in connection with duck decoys.

There has therefore been shown and described an improved duck decoy 10 which accomplishes at least all of its intended objectives.

I claim:

1. An improved waterfowl decoy comprising:
a main body including an underside, said main body having the general configuration of a selected waterfowl;
a keel structure including a longitudinally extended hollow keel tube mounted on said underside of said main body;
an anchor weight having a configuration such that at least a portion of said anchor weight fits within said hollow keel tube;
a generally tangle-free anchor line connected to and extending from said anchor weight up to one end of said hollow keel tube and extending through at least a portion of said hollow keel tube such that the anchor line extends at least partially through said hollow keel tube; and
said anchor weight at least partially fitting within said hollow keel tube when said anchor weight is in a storage position with said generally tangle-free anchor line being pulled up and through said hollow keel tube whereby said anchor weight is releasably securable at least partially within said hollow keel tube.

2. The improved waterfowl decoy of claim 1 wherein said main body is constructed of a molded and formed plastic material and has a center longitudinal axis.

3. The improved waterfowl decoy of claim 2 wherein said longitudinally extended hollow keel tube is generally cylindrical in shape and extends generally parallel with said center longitudinal axis of said main body.

4. The improved waterfowl decoy of claim 3 wherein said anchor weight is configured to fit entirely within said hollow keel tube when said anchor weight is in said storage position.

5. The improved waterfowl decoy of claim 1 further comprising an anchor line clip mounted on one of said hollow keel tube and said main body, said anchor line clip operative to releasably secure said anchor line to generally retain said anchor weight in said storage position at least partially within said hollow keel tube.

6. The improved waterfowl decoy of claim 1 wherein said anchor line is constructed of non-tangling plastic line.

7. An improved waterfowl decoy comprising:
a main body including an underside, said main body having the general configuration of a selected waterfowl;
a keel structure including a longitudinally extended hollow keel tube mounted on said underside of said main body;
an anchor weight having a configuration such that said anchor weight is receivable within said hollow keel tube;
a generally tangle-free anchor line connected to and extending from said anchor weight up to one end of said hollow keel tube and extending through at least a portion of said hollow keel tube such that the anchor line extends at least partially through said hollow keel tube;
an anchor line clip mounted on one of said hollow keel tube and said main body, said anchor line clip operative to generally prevent said anchor line from paying out through said hollow keel tube; and
said anchor weight generally entirely fitting within said hollow keel tube when said anchor weight is in a storage position with said generally tangle-free anchor line being pulled up and through said hollow keel tube and secured within said anchor line clip whereby said anchor weight is releasably securable within said hollow keel tube.

8. The improved waterfowl decoy of claim 7 wherein said main body is constructed of a molded and formed plastic material and has a center longitudinal axis.

9. The improved waterfowl decoy of claim 8 wherein said longitudinally extended hollow keel tube is generally cylindrical in shape and extends generally parallel with said center longitudinal axis of said main body.

10. The improved waterfowl decoy of claim 7 wherein said anchor line is constructed of non-tangling plastic line.

11. An improved waterfowl decoy comprising:
a molded plastic main body including an underside, said main body having the general configuration of a duck;
a keel structure including a longitudinally extended generally cylindrical hollow keel tube having an inner diameter, said hollow keel tube mounted on said underside of said main body;
an anchor weight having a generally cylindrical cross-sectional shape and a maximum width less than said inner diameter of said hollow keel tube such that said anchor weight is receivable and retainable within said hollow keel tube;
a generally tangle-free anchor line connected to and extending from said anchor weight up to one end of said hollow keel tube and extending through at least a portion of said hollow keel tube such that the anchor line extends at least partially through said hollow keel tube;
an anchor line securement means mounted on one of said hollow keel tube and said main body, said anchor line securement means operative to generally prevent said anchor line from paying out through said hollow keel tube when engaged; and
said anchor weight generally entirely fitting within said hollow keel tube when said anchor weight is in a storage position with said generally tangle-free anchor line being pulled up and through said hollow keel tube and secured within said anchor line securement means whereby said anchor weight is releasably securable within said hollow keel tube during storage and transport thereof.
